(19) United States
(12) Patent Application Publication
(10) Pub. No.: US 2007/0150424 A1
(43) Pub. Date: Jun. 28, 2007

(54) Neural network model with clustering ensemble approach

(75) Inventor: Boris M. Igelnik, Richmond Heights, OH (US)

Correspondence Address: HOWISON & ARNOTT, L.L.P, P.O. BOX 741715, DALLAS, TX, 75374-1715, US

(73) Assignee: Pegasus Technologies, Inc.

(21) Appl. No.: 11/315,746

(22) Filed: Dec. 22, 2005

(51) Int. Cl. G06N 3/02

(52) U.S. Cl. 706/15

(57) ABSTRACT

A predictive global model for modeling a system includes a plurality of local models, each having: an input layer for mapping into an input space, a hidden layer and an output layer. The hidden layer stores a representation of the system that is trained on a set of historical data, wherein each of the local models is trained on only a select and different portion of the set of historical data. The output layer is operable for mapping the hidden layer to an associated local output layer of outputs, wherein the hidden layer is operable to map the input layer through the stored representation to the local output layer. A global output layer is provided for mapping the outputs of all of the local output layers to at least one global output, the global output layer generalizing the outputs of the local models across the stored representations therein.

### CROSS REFERENCE TO RELATED APPLICATIONS

This application is related to U.S. patent application Ser. No. 10/982,139, filed Nov. 4, 2004, entitled “NON-LINEAR MODEL WITH DISTURBANCE REJECTION,” (Atty, Dkt. No. PEGT-26,907), which is incorporated herein by reference.

### TECHNICAL FIELD OF THE INVENTION

The present invention pertains in general to creating networks and, more particularly, to a modeling approach for modeling a global network with a plurality of local networks utilizing an ensemble approach to create the global network by generalizing the outputs of the local networks.

### BACKGROUND OF THE INVENTION

In order to generate a model of a system for the purpose of utilizing that model in optimizing and/or controlling the operation of the system, it is necessary to generate a stored representation of that system wherein inputs generated in real time can be processed through the stored representation to provide on the output thereof a prediction of the operation of the system. Currently, a number of adaptive computational tools (nets by way of definition) exist for approximating multi-dimensional mappings with application in regression and classification tasks. Some such tools are nonlinear perceptrons, radial basis function (RBF) nets, projection pursuit nets, hinging hyper-planes, probablistic nets, random nets, high-order nets, multi-variate (multi-dimensional), adaptive regression splines (MARS) and wavelets, to name a few.

There are provided to each of these nets a multidimensional input for mapping through the stored representation to a lower dimensionality output. In order to define the stored representation, the model must be trained. Training of the model is typically tasked with a non-linear multi-variated optimization. With a large number of dimensions, a large volume of data is required to build an accurate model over the entire input space. Therefore, to accurately represent a system, a large amount of historical data needs to be collected, which is an expensive process, not to mention the fact that the processing of these larger historical data sets results in increasing computational problems. This is sometimes referred to as the “curse of dimensionality.” In the case of time-variable multidimensional data, this “curse of dimensionality” is intensified, because it requires more inputs for modeling. For systems where data is sparsely distributed about the entire input space, such that it is “clustered” in certain areas, a more difficult problem exists, in that there is insufficient data in certain areas of the input space to accurately represent the entire system. Therefore, the competence factor in results generated in the sparsely populated areas is low. For example, in power generation systems, there can be different operating ranges for the system. There could be a low load operation, intermediate load operation and a high load operation. Each of these operational modes results in a certain amount of data that is clustered about the portion of the space associated with that operating mode and does not extend to other operating loads. In fact, there are regions of the operating space where it is not practical or economical to operate the system, thus resulting in no data in those regions with which to train the model. To build a network that traverses all of the different regions of the input space requires a significant amount of computational complexity. Further, the time to train the network, especially with changing conditions, can be a difficult problem to solve.

### SUMMARY OF THE INVENTION

The present invention disclosed and claimed herein, in one aspect thereof, comprises a predictive global model for modeling a system. The global model includes a plurality of local models, each having: an input layer for mapping the input space in the space of the inputs of the basis functions, a hidden layer and an output layer. The hidden layer stores a representation of the system that is trained on a set of historical data, wherein each of the local models is trained on only a select and different portion of the set of historical data. The output layer is operable for mapping the hidden layer to an associated local output layer of outputs, wherein the hidden layer is operable to map the input layer through the stored representation to the local output layer. A global output layer is provided for mapping the outputs of all of the local output layers to at least one global output, the global output layer generalizing the outputs of the local models across the stored representations therein.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates an overall diagrammatic view of the trained network;

FIG. 2 illustrates a diagrammatic view of a flowchart for taking a historical set of data and training a network and retraining a network for use in a particular application;

FIG. 3 illustrates a diagrammatic view of a generalized neural network;

FIG. 4 illustrates a more detailed view of the neural network illustrating the various hidden nodes;

FIG. 5 illustrates a diagrammatic view for the ensemble algorithm operation;

FIG. 6 illustrates the plot of the operation of the adaptive random generator (ARG);

FIGS. 7a and 7b illustrate a flow chart depicting the ensemble operation;

FIG. 8a illustrates a diagrammatic view of the optimization algorithm for the ARG;

FIG. 8b illustrates a plot of minimizing the numbers of nodes;

FIG. 9 illustrates a plot of the input space showing the scattered data;

FIG. 10 illustrates the clustering algorithms;

FIG. 11 illustrates the clustering algorithm with generalization;

FIG. 12 illustrates a diagrammatic view of the process for including data in a cluster;

FIG. 13 illustrates a diagrammatic view for use in the clustering algorithms

FIG. 14 illustrates a diagrammatic view of the training operation for the global net;

FIG. 15 illustrates a flow chart depicting the original training operation;

FIG. 16 illustrates a flow chart depicting the operation of retraining the global net;

FIG. 17 illustrates an overall diagram of a plant utilizing a controller with the trained model of the present disclosure; and

FIG. 18 illustrates a detail of the operation of the plant and the controller/optimizer.

### DETAILED DESCRIPTION OF THE INVENTION

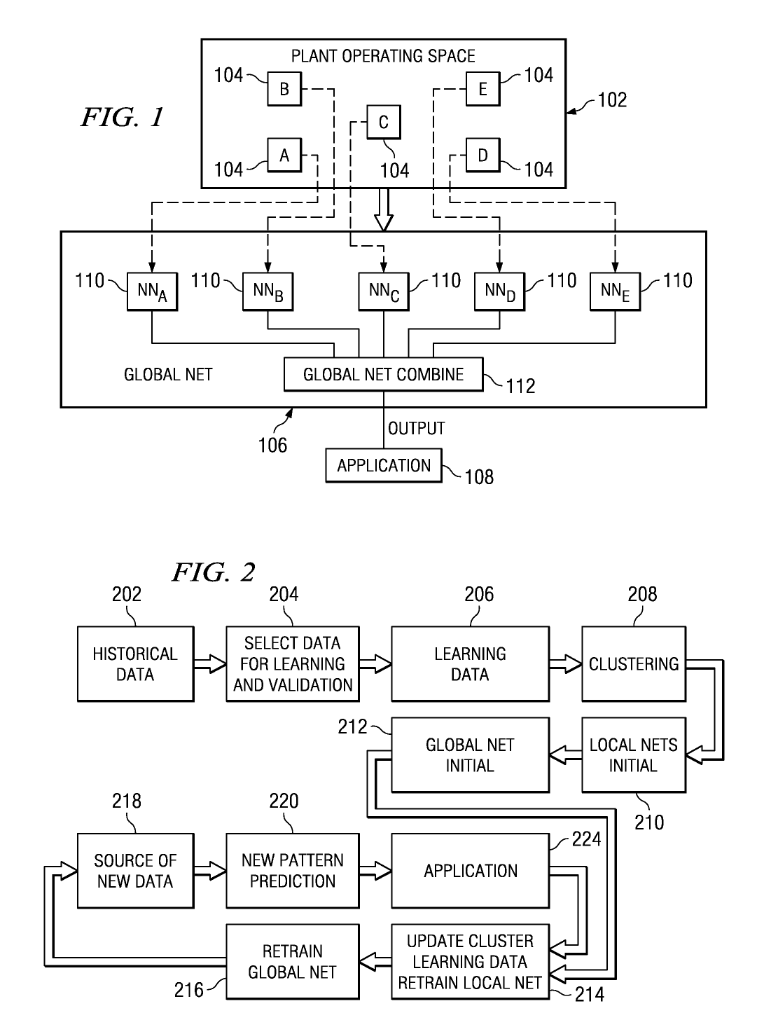

Referring now to FIG. 1, there is illustrated a diagrammatic view of the global network utilizing local nets. A system or plant (noting that the term “system” and “plant” are interchangeable) operates within a plant operating space 102. Within this space, there are a number of operating regions 104 labeled A-E. Each of these areas 104 represent a cluster of data or operating regions wherein a set of historical input data exists, derived from measured data over time. These clusters are the clusters of data that is input to the plant. For example, in a power plant, the region 104 labeled “A” could be the operating data that is associated with the low power mode of operation, whereas the region 104 labeled “E” could be the region of input space 102 that is associated with a high power mode of operation. As one would expect, the data for the regions would occupy different areas of the input space with the possibility of some overlap. It should be understood that the data, although illustrated as two dimensional, is actually multidimensional. However, although the plant would be responsive to data input thereto that occupied areas other that in the clusters A-3, operation in these regions may not be economical or practical. For example, there maybe regions of the operating space in which certain input values will cause damage to the plant.

The data from the input space is input to a global network 106 which is operable to map the input data through a stored representation of the plant or operating system to provide a predicted output. This predicted output is then used in an application 108. This application could be a digital control system, an optimizer, etc.

The global network, as will be described in more detail herein below, is comprised of a plurality of local networks 110, each associated with one of the regions 104. Each local network 110, in this illustration, is comprised of a non-linear neural network. However, other types of networks could be utilized, linear or non-linear. Each of these networks 110 is initially operable to store a representation of the plant, but trained only on data from the associated region 104, and provide a predicted output therefrom. In order to provide this representation, each of the individual networks 110 is trained only on the historical data set associated with the associated region 104. Thereafter, when data is input thereto, each of the networks 110 will provide a prediction on the output thereof. Thus, when data is input to all of the networks 110 from the input space 102, each will provide a prediction. Also, as will be described herein below, each of the networks 110 can have a different structure.

The prediction outputs for each of the networks 110 are input to a global net combining block 112 which is operable to combine all of the outputs in a weighted manner to provide the output of the global net 106. This is an operation where the outputs of the networks 110 are “generalized” over all of the network 110. The weights associated with this global net combine block 112 are learned values which are trained in a manner that will be described in more detail herein below. It should be understood that when new input pattern arrives, the global net 106 predicts the corresponding output based on the data previously included in the training set. To do so, it temporarily include the new pattern in the closest cluster and obtains an associated local net output. With small time lag, the net will also obtain the actual local net output (not stable state one). Thereafter, substituting the attributes of all local nets into the formula for global net 106, the output of the global net 106 for a new pattern will be obtained. That completes the application for that instance. The next step is a recalculation step for recalculating the clustering parameters, retraining of the corresponding local net and the global net, and then proceeding on to the next new pattern. This will be described in more detail herein below with respect to FIG. 2. It is noted that this global net 106 is a linear network. As will also be described herein below, each of the networks 110 operates on data that is continually changing. Thus, there will be a need to retrain the network on new patterns of historical data, it being noted that the amount of data utilized to train any one of the neural nets 110 is less than that required to train a single multidimensional network, thus providing for a less computationally intensive training algorithm. This allows new patterns to be entered into a particular cluster (even changing the area of operating space 102 that a particular cluster 104 will occupy) and allow only the associated network to be “retrained” in a fairly efficient manner and, with the global net combine block 112 also retrained. Again, this will be described in more detail herein below.

Referring now to FIG. 2, there is illustrated a diagrammatic view of the overall operation of creating the global net 106 and retraining it for use with the application 108. The first step in the operation is to collect historical data, denoted by a box 202. This historical data is data that was collected over time and it is comprised of the plurality of patterns of data comprising measured input data to a system or plant in conjunction with measured output data that is associated with the inputs. Therefore, if the input is defined as a vector of inputs x and the output is defined as the vector of outputs y, then a pattern set would be (x,y). This historical data can be of any size and it is just a matter of the time involved. However, this data is only valid over the portion of the input space which is occupied by the vector x for each pattern. Therefore, depending upon how wide ranging the inputs are to the system, this will define the quality of the input set of historical data. (Note that there are certain areas of the input space that will be empty, due to the fact that it is an area where the system can not operate due to economics, possible damage to the system, etc.) The next step is to select among the collected data the portion of the data that is associated with learning and the portion that is associated with validation. Typically, there would be a portion of the data on which the network is trained and a portion reserved for validation of network after training to insure that the network is adequately trained. This is indicated at a block 204. The next step is to define learning data, in a block 206 which is then subjected to a clustering algorithm in a block 208. This basically defines certain regions of the input space around which the data is clustered. This will be described in more detail herein below. Each of these clusters then has a local net associated therewith and this local net is trained upon the data in that associated cluster. This is indicated in a block 210. This will provide a plurality of local nets. Thereafter, there is provided an overall global net to provide a single output vector that combines the output of each of the local nets in a manner that will be described herein below. This is indicated in a block 212. Once the initial global net is defined, the next step is to take new patterns that occur and then retrain the network. As will be described herein below, the manner of training is to define which clustered the new input data is associated with and only train that local net. This is indicated in a block 214. After the local net is trained, with remaining local nets not having to be trained, thus saving processing time, the overall global net is then retrained, as indicated by a block 216. The program will then flow to a block 218 to provide a source of new data and then provide a new pattern prediction in a block 220 for the purpose of operating the application, which is depicted by a block 224. The application will provide new measured data which will provide new patterns for the operation of the block 214. Thus, once the initial local nets and global net have been determined, i.e., the local nets have been both defined and trained on the initial data, it is then necessary to add new patterns to the data set and then update the training of only a single local net and then retrain the overall global net.

Prior to understanding the clustering algorithm, the description of each of the local networks will be provided. In this embodiment, each of the local networks is comprised of a neural network, this being a nonlinear network. The neural network is comprised of input layer 302 and the output layer 304 with a hidden layer 306 disposed there between. The input layer 302 is mapped through the hidden layer 306 to the output layer 304. The input is comprised of a vector x(t) which is a multi-dimensional input and the output is a vector y(t), which is a multi-dimensional output. Typically, the dimensionality of the output is significantly lower than that of the input.

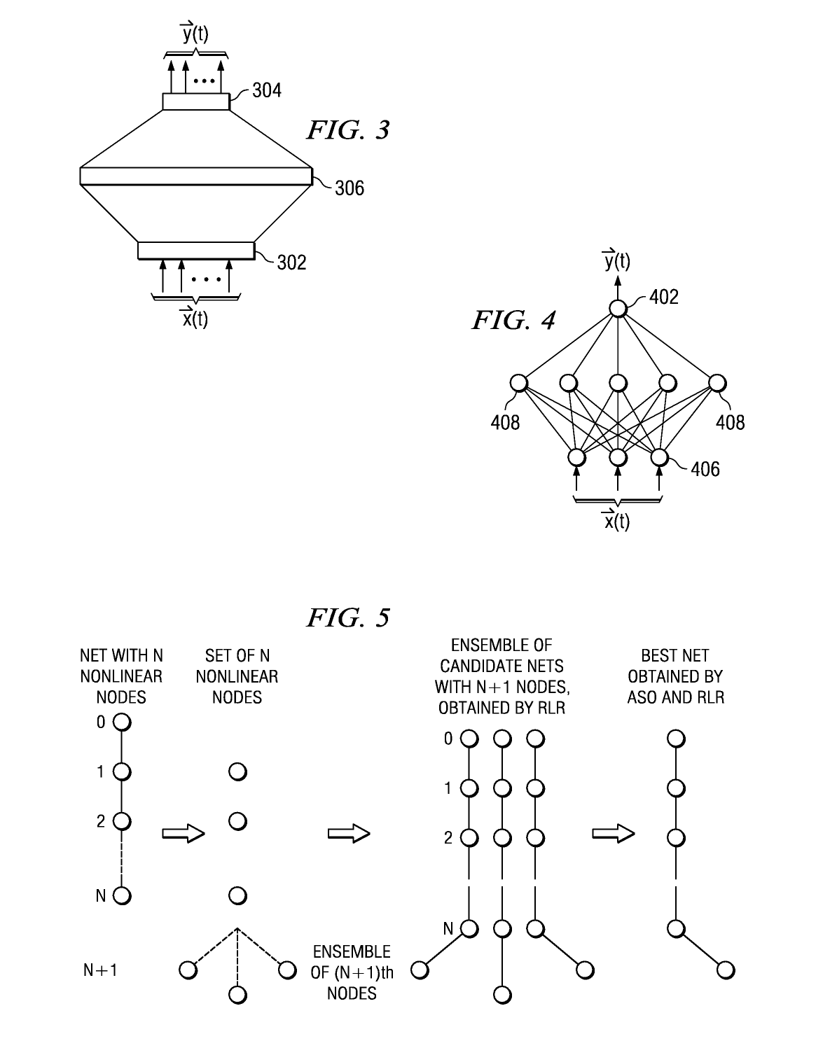

Referring now to FIG. 4, there is illustrated amore detailed diagram of the neural network of FIG. 3. This neural network is illustrated with only a single output y(t) with three input nodes, representing the vector x(t). The hidden layer 306 is illustrated with five hidden nodes 408. Each of the input nodes 406 is mapped to each of the hidden nodes 408 and each of the hidden nodes 408 is mapped to each of the output nodes 402, there only being a single node 402 in this embodiment. However, it should be understood that a higher dimension of outputs can be facilitated with a neural network. In this example, only a single output dimension is considered. This is not unusual. Take, for example, a power plant wherein the primary purpose of the network is to predict a level of NOx. It should also be understood that a hidden layer 408 could consist of tens to hundreds of nodes and, therefore, it can be seen that the computational complexity for determining the mapping of the input nodes 406 through the hidden nodes 408 to the output node 402 can involve some computational complexity in the first layer. Mapping from the hidden layer 306 to the output node 402 is less complex.

The Ensemble Approach (EA)

In order to provide a more computational efficient learning algorithm for a neural network, an ensemble approach is utilized, which basically utilizes one approach for defining the basis functions in the hidden layer, which are a function of both the input values and internal parameters referred to as “weights,” and a second algorithm for training the mapping of the basis function to the output node 402. The EA is the algorithm for training one hidden layer nets of the following form:

$$\tilde{y} ( x , w ) = \tilde{f} ( x , W ) = {w}_{0}^{ext} + {\sum }_{n = 1}^{{N}_{max}} {w}_{n}^{ext} {φ}_{n} ( x , {w}_{n}^{int} ) , \qquad ( 001 )$$

where \tilde{ƒ}(x,W) is the output of the net (can be scalar, or vector, usually low dimensional), x is the multi-dimensional input, {wₙ^{ext}, n=0, 1, . . . Nₘₐₓ} is the set of external parameters, {wₙ^{int}, n=1, . . . Nₘₐₓ} is the set of internal parameters, W is the set of net parameters, which include both the external and internal parameters, {φₙ, n=1, . . . Nₘₐₓ} is the set of (nonlinear) basis functions, Nₘₐₓ is the maximal number of nodes, dependent on the class of application, time and memory constraints. The external parameters can be either scalars or vectors, if the output is the scalar or vector respectively. The construction given by equation (1) is very general. Further for simplicity of notations it is assumed that there is only one output. In practice basis functions are implemented as superpositions of one-dimensional functions in the following equation:

$${φ}_{n} ( x , {w}_{n}^{int} ) = g ( {w}_{n 01}^{int} , {\sum }_{i = 1}^{d} {w}_{ni 1}^{int} {h}_{ni} ( {x}_{i} , {w}_{ni 2}^{int} ) ) , n = 1 , … {N}_{max} , \qquad ( 002 )$$

The following will provide a general description of the EA. The EA builds and keeps in memory all nets with the number of hidden nodes N, 0≦N≦Nₘₐₓ, noting that each of the local nets can have a different number ofhidden nodes associated therewith. However, since all of the local nets model the overall system and are mapped from the same input space, they will have the same inputs and, thus, substantially the same level of dimensionality between the inputs and the hidden layer.

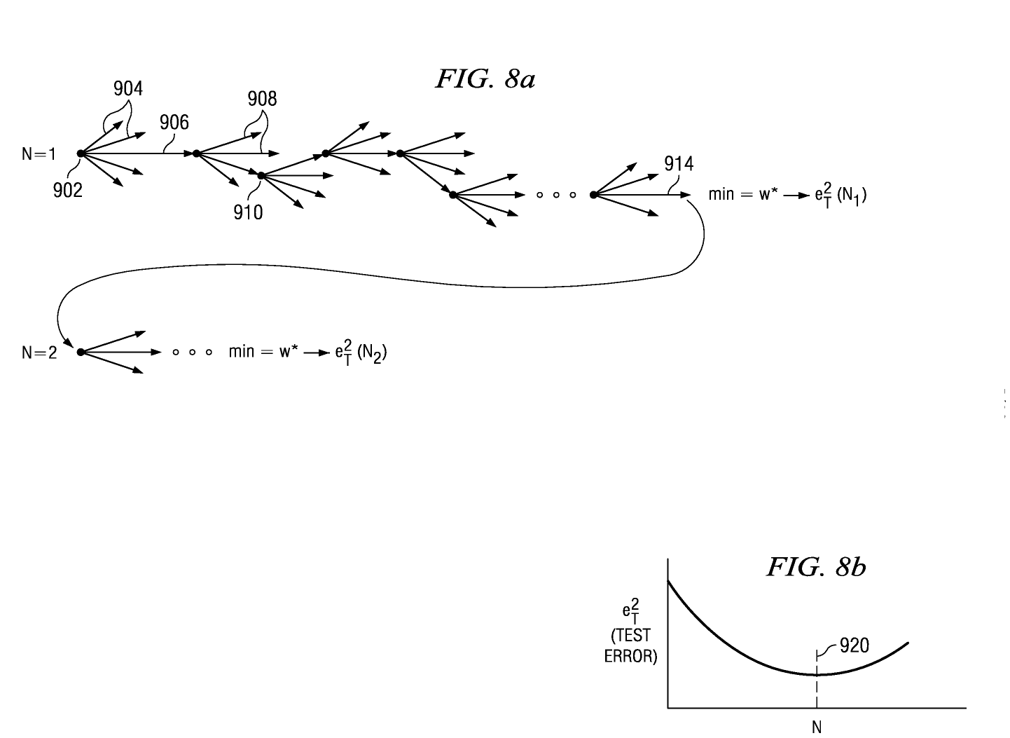

Denote the historical data set as:
E={(xₚ,yₚ),p=1, . . . P}, (003)
where “p” denotes the pattern and (xₚ,yₚ) is an input-output pair connected by an unknown functional relationship yₚ=ƒ(xₚ)+εₚ, where εₚ is a stochastic process (“noise”) with zero mean value, unknown variance σ, and independent εₚ, p=1, . . . P. The data set is first divided at random into three subsets (Eₜ E_{g} and Eᵥ), as follows:
Eₜ={(xₚ^{t},yₚ^{t}),p=1, . . . Pₜ}, E_{g}={(xₚ^{g},yₚ^{g}),p=1, . . . P_{g}}, (004)
and:
Eᵥ={(xₚ^{v},yₚ^{v}),p=1, . . . Pᵥ} (005)
for training, testing (generalization), and validation, respectively. The union of the training set Eₜ and the generalization set E_{g} will be called the learning set E₁. The procedure of randomly dividing a set E into two parts E₁ and E₂ with probability p is denoted as divide (E, E₁, E₂, p), where each pattern from E goes to E1 with probability p, and to E₂=E−E₁ with probability 1−p. This procedure is first applied to divide the data set into training and validation sets, and sending data to the validation set with a probability of 0.03, therefore calling divide (E, E₁, Eᵥ, 0.97). Thus, the learning data is divided into sets for training and generalization by calling divide (E₁, Eₜ, E_{g}, 0.75). The data set for validation is never used for learning and used only for checking after learning is completed. For validation purposes only, roughly 3% of the total data is used. The remaining learning data is divided so that roughly 75% of learning data goes to the training set while 25% is left for testing. Training data is completely used for training. The testing set is used after training is completed, for each of the nets with N, 0≦N≦Nₘₐₓ nodes, to calculate a set of testing errors, testMSE_{N}, for 0≦N≦Nₘₐₓ, A special procedure optNumberNodes (testMSE) uses the set of testing errors to determine the optimal number of nodes for each local net, which will be described herein below. This procedure finds the global minimum of testMSE_{N} over N, 0≦N≦Nₘₐₓ. (As will be described herein below with reference to FIG. 8b, the testing error, testMSE_{N}, as a function of the number of nodes (basis functions) can have many local minima).

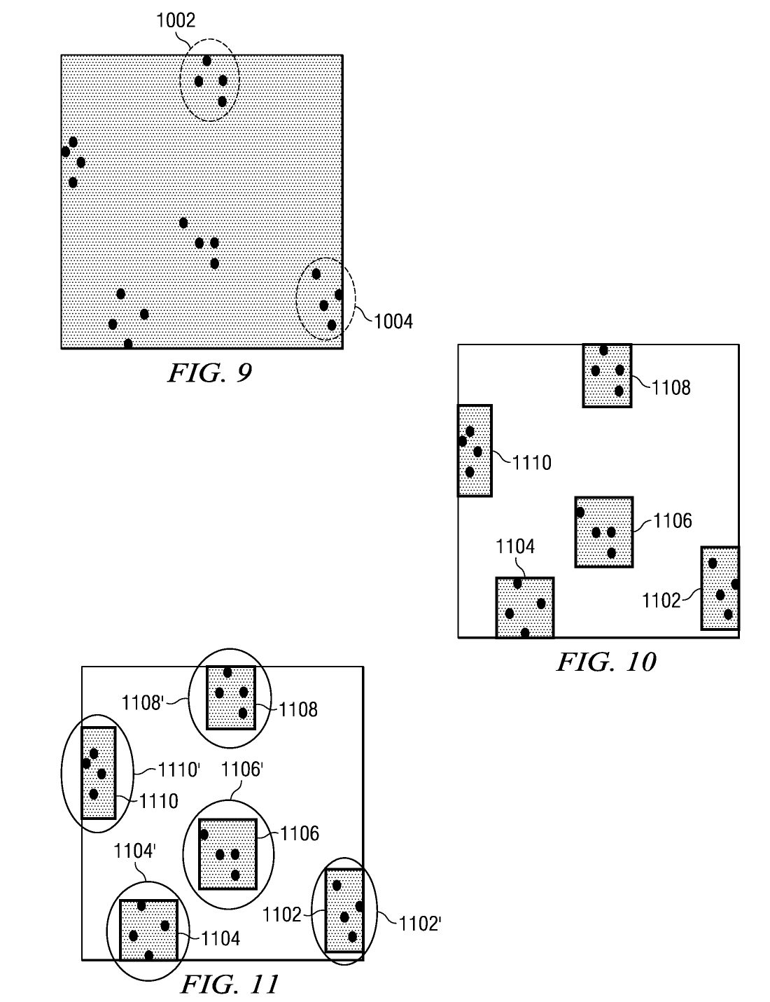

The algorithm for finding the number of nodes is as follows:
(1) It finds the local minima of the function testMSE_{N} of the discrete parameter N by the condition to have at the point N a local minima of:

$$\{ \begin{matrix}{testMSE}_{N + 1} \geq {testMSE}_{N} \\ {testMSE}_{N - 1} \geq {testMSE}_{N} ;\end{matrix} \qquad ( 006 )$$
(2) Among all of the local minima, it finds the one with the smallest testMSE_{N} shown below in FIG. 9b as a point (N_{glob}, e²_{glob});
(3) It then finds all of the local minima with N≦N_{glob} such that:
   testMSE_{N}≦e_{glob}²(1+0.01*PERCENT)=δ(PERC) (007)

The value of N satisfying the above inequality is called the optimal number of nodes and is denoted as N_{*}. Two cases are shown in FIG. 8 by two horizontal lines, one with a small value of PERCENT and another with a high value of PERCENT, having a mark δ (PERC). In case of a small value of PERCENT, the optimal number of nodes is equal to N_{*}=N_{glob}, while in the case of a high value of PERCENT, it equals N_{*}=N_{PERC}.

The default value of the parameter Percent equals 20. This procedure will tolerate some increase in the minimal testing error in order to obtain a shorter net (with lesser number of nodes). This is an algorithmic solution for the number of local net nodes. Another aspect of the training algorithm associated with the EA is training with noise. Originally noise was added to the training output data before the start of training in the form of artificially simulated Gaussian noise with the variance equal to the variance of the output in the training set. This added noise is multiplied by a variable Factor, manually adjusted for the area of applications to the default value 0.25. Increase of the factor will decrease net performance on the training data while causing an increase of performance on the future prediction.

For a more detailed description of the training, a diagrammatic view of how the network is trained may be more appropriate. With further reference to FIG. 4, it can be seen that the mapping from the input nodes 406 to the hidden nodes 408 involves multiple dimensions, wherein each input node is mapped to each hidden node. Each of the hidden nodes 408 is represented by a basis function, such as a radial basis function, a sigmoid function, etc. Each of these have associated therewith an internal weight or internal parameter “w” such that, during training, each of the input nodes is mapped to the basis function where the basis function is a function of both the value at the input node and its associated weight for mapping to that hidden node. This results in an output from that particular hidden node, the basis function associated therewith and the weight associated with a particular input node defining what the output from the hidden node is when all of the inputs mapped to that hidden node are summed over all of the input nodes. Thus, the computational complexity of such a learning algorithm can be appreciated, and it can further be appreciated that standard “directed” learning techniques, such as back propagation, require a considerable amount of data to accurately build the model. Thereafter, there is a weighting factor provided between the hidden node 408 and the output node 402. These are typically referred to as the external parameters and, as will be described herein below, they form part of a linear network, which has the associated weights trained.

In the ensemble approach, the Adaptive Stochastic Optimization (ASO) technique intertwines with the second algorithm, a Recursive Linear Regression (RLR) algorithm, comprising the basic recursive step of the learning procedure: building the trained and tested net with (N+1) hidden nodes from the previously trained and tested net with N hidden nodes (in the rest of this paragraph the word “hidden” will be omitted). The ASO, freezes the nodes φ₁, . . . φ_{N}, which means keeping frozen their internal vector weights w₁ . . . , w_{N}, and then generates the ensemble of candidates in the node φ_{N+1}, which means generating the ensemble of their internal vector weights {w_{N+1}}. The typical size of the ensemble is in the range 50-200 members. The ASO goes through the ensemble of internal vector-weights to find, in the end of the ensemble, its member w_{*,N+1}, which together with the frozen w₁, . . . , w_{N} gives the net with N+1 nodes. This net is the best among all members in the ensemble of nets with N+1 nodes, which means the net with minimal testing error. The weight w_{*,N+1} becomes new weight w_{N+1} and the procedure for choosing all internal weights for a training net with (N+1) nodes has been completed. So far, this discussion has been focused on the ASO and on the procedure for choosing internal weights. However, the calculation of the training error requires, first of all, building a net, which requires calculating the set of external parameters w^{ext}₀, w^{ext}₁, . . . , w^{ext}_{N+1}. These external parameters are determined utilizing the RLR for each member of the ensemble. The RLR also includes the calculation of the net training error.

From the standpoint of the ASO function, prior to a detailed explanation herein below, this is an operation where a specially constructed Adaptive Random Generator (ARD) generates the ensemble of randomly chosen internal vector weights (samples). The first member of the ensemble is generated according to a flat probability density function. If the training error of a net with (N+1) nodes, corresponding to the next member of the ensemble, is less than the currently achieved minimal training error, then the ARD changes the probability density function utilizing this information.

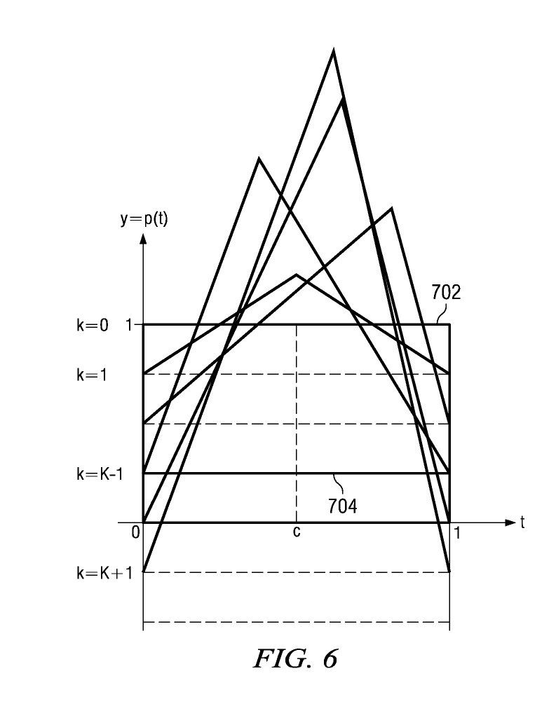

With reference to FIG. 5, there is illustrated a general diagrammatic view of the interaction between ASO and RLR in the main recursive step: going from the trained and tested net with N nonlinear nodes to the trained and tested net with (N+1) nodes. More details will be described herein below. The first from the left picture illustrates, in a simplified view, the starting information of the step: the trained and tested net with N (nonlinear) nodes referred to as the “N-net”), determined by its external and internal parameters w^{ext}₀, w^{ext}₁, . . . , w^{ext}_{N} and w^{int}₁ , . . . , w^{int}_{N}, respectively. The next step in the process illustrates that the ASO actually disassembles the N-net keeping only the internal parameters, and generates the ensemble of candidate internal vector weights for the (N+1) node. The next step in the process illustrates that, by applying the RLR algorithm to each member (sample) of the ensemble, the ensemble of (N+1)-nets (passes) is determined by calculating the external parameters of each candidate (N+1)-nets. The same RLR algorithm calculates the training mean squared errors (MSE) for each sample. The next to the last step in the process illustrates that, in the end of the ensemble, the ASO obtains the best net in the ensemble and stores in memory its internal and external parameters until the end of building all best in training N-nets, 0≦N≦N_{MAX}. For each such best net the testing MSE is calculated.

As was noted in the beginning of this section, EA builds a set of nets, each with N nodes, 0≦N≦Nₘₐₓ. This process starts with N=0. For this case the net output is a constant, which optimal value can be calculated directly as

$${\tilde{f}}_{0} ( x , W ) = \frac{1}{{P}_{t}} {\sum }_{p = 1}^{{P}_{t}} {y}_{p}^{t} . \qquad ( 008 )$$

For the purpose of further discussion of the EA the design P_{N} and its pseudo-inverse P_{N+} matrices for the net with arbitrary N nodes is defined as:

$${P}_{N} = [ \begin{matrix}1 & {φ}_{1} ( {x}_{1} , {w}_{1} ) & ⋯ & {φ}_{N} ( {x}_{1} , {w}_{N} ) \\ 1 & {φ}_{1} ( {x}_{2} , {w}_{1} ) & ⋯ & {φ}_{N} ( {x}_{2} , {w}_{N} ) \\ ⋯ & ⋯ & ⋯ & ⋯ \\ 1 & {φ}_{1} ( {x}_{P} , {w}_{1} ) & ⋯ & {φ}_{N} ( {x}_{P 1} , {w}_{N} )\end{matrix} ] \qquad ( 009 )$$

In equation 009 the bold font is used for vectors in order not to confuse, for example, the multi-dimensional input x₁ with its one-dimensional component x₁. The matrix P_{N} is the Pₜ×(N+1) matrix (Pₜ rows and N+1 columns). It can be noticed that if matrix P_{N} is known, then matrix P_{N+1} can be obtained by the recurrent equation:

$${P}_{N + 1} = [ \begin{matrix}{φ}_{N + 1} ( {x}_{1} , {w}_{N + 1} ) \\ {φ}_{N + 1} ( {x}_{2} , {w}_{N + 1} ) \\ {P}_{N} \\ {φ}_{N + 1} ( {x}_{{P}_{t}} {w}_{N + 1} )\end{matrix} ] . \qquad ( 010 )$$

The matrix P_{N+} is the (N+1)×Pₜ matrix and has some properties of the inverse matrix (the inverse matrices are defined only for quadratic matrices, the pseudo-inverse P_{N+} is not quadratic because in right designed net should be N<<Pₜ). It can be calculated by the following recurrent equation:

$${P}_{N + 1 , +} = [ \frac{{P}_{N +} - {p}_{N + 1} {k}_{N + 1}^{T}}{{k}_{N + 1}^{T}} ] \qquad ( 011 )$$

where:

$${k}_{N + 1} = \frac{{P}_{N + 1} - {P}_{N +} {p}_{N + 1}}{{‖ {P}_{N + 1} - {P}_{N} {P}_{N +} {p}_{N + 1} ‖}^{2}} if {p}_{N + 1} - {P}_{N} {P}_{N +} {p}_{N + 1} \neq 0. \qquad ( 012 )$$

P_{N+1}=[φ_{N+1}(x₁,w_{N+1}), . . . φ_{N+1}(x_{P}_{ₜ},w_{N+1})]^{T}. (013)

In order to start using equations (010)-(013) for recurrent calculation of matrices P_{N+1} and P_{N+1,+} through matrices P_{N} and P_{N+} the initial conditions are defined as:

$${P}_{0} = [ {\underbrace{1 , 1 , … 1}}_{{P}_{t} times} , ] {P}_{0 +} = [ {\underbrace{1 / {P}_{t} , 1 / P , … 1 / P}}_{{P}_{t} times} ] . \qquad ( 014 )$$

Then the equations (010)-(013) are applied in the following order for N=0. First the one-column matrix p₁ is calculated by equation (012). Then the matrix P₀ and the matrix p₁ are used in equation (010) to calculate the matrix P₁. After that equation (013) calculates the one-column matrix k₁, using P₀, P₀₊ and p₁. Finally equation (011) calculates the matrix P₁₊. That completes calculation of P₁ and P₁₊ using P₀ and P₀₊. This process is further used for calculation of matrices P_{N} and P_{N+} for 2≦N≦Nₘₐₓ.

It can be seen that for any N the matrices P_{N} and P_{N+} satisfy the equation:
P_{N+}P_{N}=I_{N+1}, (015)
where I_{N+1} is the (N+1)×(N+1) unit matrix. At the same time the matrix P_{N}P_{N+} is the matrix which projects any P₁-dimensional vector on the linear subspace spanned by the vectors p₀, p₁, . . . p_{N}. That justifies the following equations:
w^{ext}=P_{N+}yₜ,\tilde{y}ₜ=P_{N}w^{ext}, (016)
where:
yₜ=[y₁^{t}, . . . y_{P}_{ₜ}^{t}]^{T} is the one-column matrix of plant training output values;
w^{ext}=[w₀^{ext}, w₁^{ext}, . . . w_{N}^{ext}]^{T} is the one-column matrix of the values of external parameters for a net with N nodes;
\tilde{y}ₜ=[\tilde{ƒ}_{N}(x₁^{t}, W), . . . \tilde{ƒ}_{N}(x_{P}_{ₜ}^{t}, W)]^{T} is the one-column matrix of the values of the net training outputs for a net with N nodes.

Equations (010)-(013) describe the procedure of Recursive Linear Regression (RLR), which eventually provides net outputs for all local nets with N nodes, therefore allowing for calculation of training MSE by equation (017):

$${e}_{N , t}^{2} = \frac{1}{{P}_{N , t}} {\sum }_{p = 1}^{{P}_{t}} {( {\tilde{y}}_{p}^{t} - {y}_{p}^{t} )}^{2} , N = 0 , 1 , … {N}_{max} . \qquad ( 017 )$$

After each calculation of the e_{N,t} the generalization (testing) error e_{N,g}, N=0, 1, . . . Nₘₐₓ is calculated by the equation (018)

$${e}_{N , g}^{2} = \frac{1}{{P}_{g}} {\sum }_{p = 1}^{{P}_{g}} {( {\tilde{y}}_{p}^{g} - {y}_{p}^{g} )}^{2} , \qquad ( 018 )$$

where:
\tilde{y}_{g}=[\tilde{ƒ}_{N}(x₁^{g},W_{N}), . . . \tilde{ƒ}_{N}(x_{P}_{_{g}}^{g},W_{N})]^{T}. (019)
It should be noted that the values of testing net outputs are calculated not by equations (010)-(016) but by the equation (001), which in this case looks like equations (020) and (021):

$$\begin{matrix}{\tilde{f}}_{N} ( x , {W}_{N} ) = {w}_{0}^{ext} + {\sum }_{n = 1}^{N} {w}_{n}^{ext} {φ}_{n} ( x , {w}_{n}^{int} ) , \\ N = 0 , … {N}_{max} , \\ x = {x}_{p}^{x} , \\ p = 1 , … {P}_{g} ,\end{matrix} \qquad ( 020 )$$

where W_{N} is the set of trained net parameters for a net with N nodes
W_{N}={wₙ^{ext},n=0,1, . . . N,wₘ^{int},m=1, . . . N}, (021)

After the process of training comes to the end with a net with N=Nₘₐₓ the procedureoptNumberNodes(testMSE) calculates the optimal number of nodes N,≦Nₘₐₓ and select the only optimal net with optimal number of nodes and corresponding set of the net parameters.

Adaptive Stochastic Optimization (ASO)

As noted hereinabove, the RLR operation is utilized to train the weights between the hidden nodes 502 and the output node 508. However, the ASO is utilized to train internal weights for the basis function to define the mapping between the input nodes 504 and hidden nodes 502. Since this is a higher dimensionality problem, the ASO solves this through a random search operation, as was described hereinabove with respect to FIGS. 5 and 6. This ASO operation utilizes the ensemble of weights:
w_{N+1}^{int}=(w_{N+1,i}^{int},i=1, . . . d) (022)
and the related ensemble of nets \tilde{ƒ}_{N+1}. The number of members in the ensemble equals to numEnsmbl=Phase1+Phase2, where the Phase1 is the number of members in Phase1 of the ensemble, while the Phase2 is the number of members in Phase2. The default values of these parameters are Phase1=25, Phase2=75. Other values of the internal parameters w₁^{int}, . . . w_{N}^{int} for building the nets \tilde{ƒ}_{N+1} are kept from the previous step of building the net \tilde{ƒ}_{N}. This methodology of optimization is based on the literature, which says that asymptotically the training error obtained by optimization of internal parameters of the last node is of the same order as the training error obtained by optimization of all net parameters. That is why the internal parameters from the previous step of the RLR are not changed but the set of external parameters completely recalculated and optimized with the RLR.

Thus, by keeping the optimal values of the internal parameters w₁^{int}, . . . w_{N}^{int} from the previous step of building the optimal net with N nodes results in the creation of the ensemble of numEnsmbl possible values of the parameter w_{N+1}^{int} by generating a sequence of all one-dimensional components of this parameter, w_{N+1,i}^{int}, i=1, . . . d, using an Adaptive Random Generator (ARG) for each component.

Referring now to FIG. 6, there is illustrated a diagrammatic view of the Adaptive Random Generator (ARG). This figure illustrates how the ASO works.

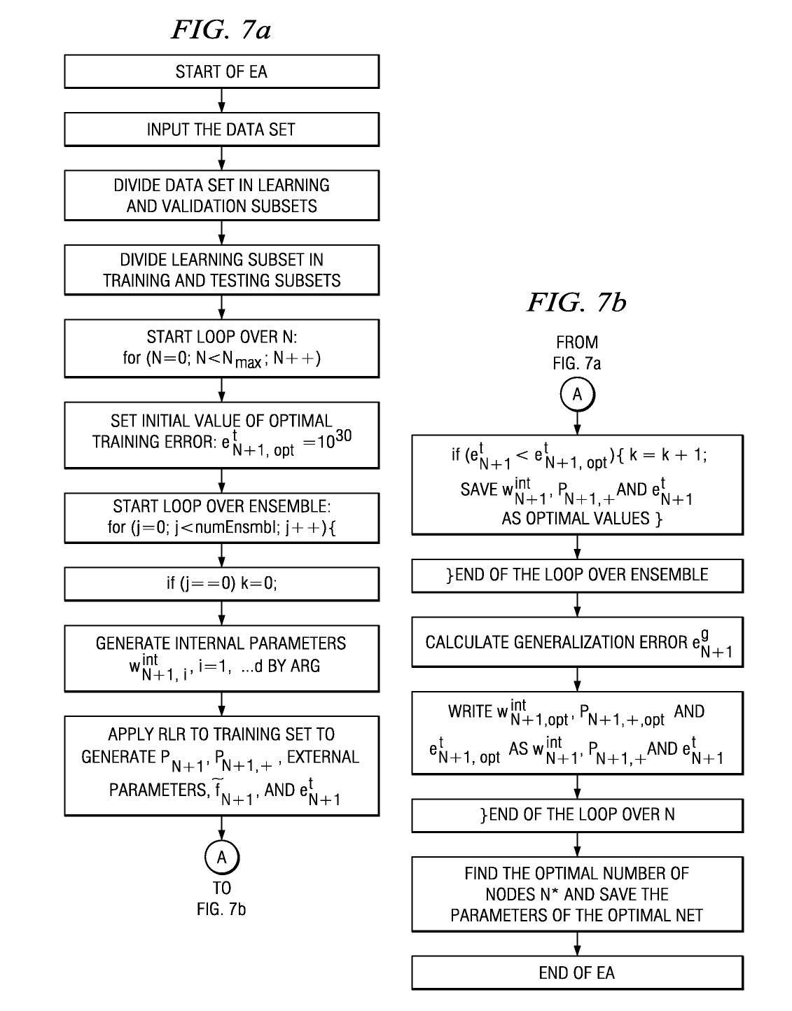

Referring now to FIG. 7a and FIG. 7b, there is illustrated a flow chart for the entire EA operating to define the local nets.

Each of the local networks, as described hereinabove, can have a different number of hidden nodes. As the ASO algorithm progresses, each node will have the weights there of associated with the basis function determined and fixed and then the output node will be determined by the RLR algorithm. Initially, the network is configured with a single hidden node and the network is optimized with that single hidden node. When the minimum weight is determined for the basis function of that single hidden node then the entire procedure is repeated with two nodes and so on. (It may be that the algorithm starts with more than a single hidden node.) For this single hidden node, there may a plurality of input nodes, which is typically the case. Thus, the above noted procedure with respect to FIG. 4, et al. is carried out for this single node such that the weights for the first input nodes mapped to the single hidden node are determined with the multiple samples and testing followed by training of the mapping of the single node to the output node with the RLR algorithm, followed by fixing those weights between the first input node and the single hidden node and then progressing to the next input node and defining the weights from that second input node to the single hidden node. This progresses through to find the weights for all of the input nodes to that single hidden node. Once the ASO has been completed for this single hidden node, then a second node is added and the entire procedure repeated. At the completion of the ASO algorithm for each node added, the network is tested and a testing error determined. This will utilize the testing data that was set aside in the data set, or it can use the same training set that the net was trained on. This testing error is then associated with that given set of hidden nodes N=1, 2, 3, . . . , Nₘₐₓ node and then the same procedure is processed for the second node until a testing error is determined for that node. The testing error will then be plotted and it will exhibit a minimum testing error for a given number of nodes beyond which the testing error will actually increase. This is graphically depicted in FIGS. 9a and 9b.

In FIG. 8a, there is illustrated first the operation for hidden node 1, the first hidden node, which is initiated at a point 902 wherein it can be seen that there are multiple samples 904 taken for this point 902 with different weights as determined by the ARG. One sample, a sample 906, will be the sample that results in the minimum mean-squared error and this will be chosen for that probability density function and then the ASO will go onto a second iteration of the samples for a second probability density function. This will occur, for the second value of the probability density function, based upon the determined weight at sample, and generate again a plurality of samples 908, of which one will be routed to a point 910 for another iteration with the probability density function associated therewith and a testing operation defined by the minimum mean-squared error associated with one of the samples 908. This will continue until all of the iterations are complete, this being a finite number, at which time a value of weights 914 will be determined to be the minimum value of the weights for the network with a single hidden node (or this could be the first node of a minimum number of hidden nodes). This final configuration will then be subjected to a testing error wherein test data will be applied to the network from a separate set of test data, for example. This will provide the testing error e_{T}² for the net with one nonlinear node. Then, a second node will be added and the procedure will be repeated and a testing error will be determined for that node. A plot of the number of nodes for the testing error as illustrated in FIG. 8b, where it can be seen that the test error will occur at a minimum 920, and that adding nodes beyond that just increases the test error. This will be the number of nodes for that local net Again, depending upon the input data in the cluster, each local net can have a different number of nodes and different weights associated with the input layer and output layers.

As a summary, the RLR and ASO procedures operate as follows. Suppose the final net consisting of the N nodes has been built. It consists of N basis functions, each determined by its own multidimensional parameter w^{int}ₙ, n=1, . . . , N connected in a linear net by external parameters w^{ext}ₙ, n=0, 1, . . . , N The process of training and testing basically consists of building a set of nets with 0, N= . . . , Nₘₐₓ nodes. The initialization of the process starts typically with N=0 and then goes recursively from N to N+1 until reaching N=Nₘₐₓ. Now the organization of the main step N→N+1 will be described. First the connections between first N nodes, provided by the external parameters, are canceled, while nodes 1, 2, . . . , N determined by their internal parameters remain frozen from the previous recursive step. Secondly to pick up a good (N+1)-th node, the ensemble of these nodes is generated. Each member of the ensemble is determined by its own internal multidimensional parameter w^{int}_{N+1} and is generated by a specially constructed random generator. After each of these internal parameters is generated, there is provided a set of (N+1) nodes which set can be combined in a net with (N+1) nodes calculating the external parameters w^{ext}ₙ, n=0, 1, . . . , N+1. This procedure of recalculating of all external parameters is not conventional but attributed to the Ensemble Approach. The conventional asymptotic result described herein above requires only calculating one external parameter w^{ext}_{N+1}. Calculating all external parameters is performed by a sequence of a few matrix algebra formulas called RLR. After these calculations are made for a given member of the ensemble, the training MSE can be calculated. The ASO provides the intelligent organization of the ensemble so that the search for the best net in the ensemble (with minimum training MSE) will be the most efficient. The most difficult problem in multidimensional optimization (which is the task of training) is the existence of many local minima in the objective function (training MSE). The essence of ASO is that the random search is organized so that as the size of ensemble increases the number of the local minima decreases and approaches one when the size of the ensemble approaches infinity. In the end of the ensemble, the net with minimal training error in the ensemble will be found, and only this net goes to the next step (N+1)→(N+2). Only for this best net with (N+1) nodes will the testing error be calculated. When N reaches Nₘₐₓ, the whole set of best nets with N nodes, 0≦N≦Nₘₐₓ nodes with their internal and external parameters will have been calculated. Then the procedure described in the herein above finds among this set of nets the only one with optimal number of nodes N_{*}, which means the net with minimal testing error.

Returning to the ASO procedure, it should be understood that random sampling of the internal parameter with its one-dimensional components means that random generator is applied subsequently to each component and only after that the process goes further.

Clustering

The ensemble net operation is based upon the clustering of data (both inputs and outputs) in a number of clusters. FIG. 9 illustrates a data space wherein there are provided a plurality of groups of data, one group being defined by reference numeral 1002, another group being defined by reference numeral 1004, etc. There can be a plurality of such groups. As noted hereinabove, each of these groups can be associated with a particular set of operational characteristics of a system. In a power plant, for example, the power plant will not operate over the entire input space, as this is not necessary. It will typically operate in certain type regions in the operating space. It might be a lower power operating mode, a high power operating mode, operating modes that differing levels of efficiency, etc. There are certain areas of the operating space that would be of such a nature that the system just could not work in those areas, such as areas where damage to the plant may occur. Therefore, the data will be clustered in particular defined and valid operating regions of the input space. The data in these defined and valid regios is normalized separately for each cluster, as illustrated in FIG. 10, wherein there are defined clusters 1102, 1104, 1106, 1108 and 1110. Since the data is normalized using maximal and minimal values of the features (inputs or outputs) to provide a significant reduction in the amount of the input space that is addressed, these clusters being the clusters where the generalization of the trained neural network is applied. Thus, the trained neural network is only trained on the data set that is associated with a particular cluster, such that there is a separate neural network for each cluster. It can be seen that the area associated with the clusters in FIG. 10 is significantly less than the area in that of FIG. 9. The clustering itself will lead to improvements both in performance and speed of calculations when generating these local networks. Each of these local networks, since they are trained separately on each cluster, will have different output values on the borders of the clusters, resulting in potential discontinuities of the neural net output when the global space of generalization is considered. This is the reason that the global net is constructed, in order to address this global space generalization problem. The global net would be constructed as a linear combination of the trained local nets multiplied by some “focusing functions,” which focus each local net on the area of the cluster related to this global net. The global net then has to be trained on the global space of the data, this being the area of FIG. 9. The global net will not only smooth the overall global output, but it also serves to alleviate the imperfections in the clustering algorithms. Therefore, the different weights that are used to combine the different local nets will combine them in different manner. This will result in an increase in the total area of reliable generalization provided by the nets. This is illustrated in FIG. 11, where it can be seen that the areas of the clusters of FIG. 10 for the clusters 1102-1010 are expanded somewhat or “generalized” as clusters 1102-1110. This is depicted with the “prime” values of the reference numerals.

The clustering algorithm that is utilized is the modified BIMSEC (basic iterative mean squared error clustering) algorithm. This algorithm is a sequential version of the well known K-Means algorithm. This algorithm is chosen, first, since it can be easily updated for new incoming data and, second, since it contains an explicit objective function for optimization. One deficiency of this algorithm is that it has a high sensitivity to initial assignment of clusters, which can be overcome utilizing initialization techniques which are well known. In the initialization step, a random sample of data is generated (the size of the sample equal to 0.1*(size of the set) was chosen in all examples). The first two cluster centers are chosen as a pair of generated patterns with the largest distance between them. For example, if n≧2 clusters are chosen, the following iterative procedure will be applied. For each remaining pattern x in the sample, the minimal distance dₙ(x) to these cluster centers is determined. The pattern with the largest dₙ(x) has been chosen as the next, (n+1)-th cluster.

The standard BIMSEC algorithm minimizes the following objective:

$${J}_{e} = {\sum }_{i = 1}^{c} {\sum }_{x = {D}_{1}} {‖ x - {m}_{i} ‖}^{2} {\to }_{{D}_{i} , {m}_{i} , {n}_{i}} min , \qquad ( 023 )$$

where c is the number of clusters, mᵢ is the center of the cluster Dᵢ, I=1, . . . c. To control the size of clusters another objective has been added:

$${J}_{u} = {\sum }_{i = 1}^{c} {( {n}_{i} - n / c )}^{2} {\to }_{{n}_{i}} min , \qquad ( 024 )$$

where n is the total number of patterns. Thus, the second objective is to keep the distribution of cluster sizes as close as possible to the uniform. The total goal of clustering is to minimize the following objective:

$$J = λ {J}_{u} {\to }_{{D}_{i} , {m}_{i} , {n}_{i}} min \qquad ( 025 )$$

where λ and μ are nonnegative weighting coefficients satisfying the condition λ+μ=1. The proper weighting depends on the knowledge of the values of Jₑ and Jᵤ. A dynamic updating of λ and μ has been implemented by the following scheme. The total number of iterations is N/M. Suppose it is desired to keep λ=a, μ=1−a, 0≦a≦1. Then in the end of each group s, s≧1 the updating of λ and μ is made by the equation:
λ=a,μ=(1−a)Jₑₛ/Jᵤₛ≧Jₑₛ
λ=aJᵤₛ/Jₑₛ,μ=1−a if Jᵤₛ<Jₑₛ. (026)

The clustering algorithm is shown schematically below.

| | |
|---|---|
| 1 | begin initialize n, c, m₁, . . . , m_{c , λ = 1, μ =0.} |
| | Make the initialization step described above. |
| 2 | set λ = a, μ = 1 − a. |
| | for (m = 1; m <= M; m++) {for (l = 1; l < (M/N); l++) {// main loop |
| 3 | do randomly select a pattern \hat{x} |
| 4 | $i ← arg {min}_{{i}^{′}} ‖ {m}_{{i}^{′}} - \hat{x} ‖ ( classify \hat{x}$ |
| 5 | if nᵢ ≠ 1 then compute |
| 6 | ${ρ}_{j} = \{ \frac{λ \frac{{‖ \hat{x} - {m}_{j} ‖}^{2} {n}_{j}}{{n}_{j} + 1} + μ ( 2 {n}_{j} + 1 ) j \neq i}{λ \frac{{‖ \hat{x} - {m}_{i} ‖}^{2} {n}_{j}}{{n}_{j} - 1} + μ ( 2 {n}_{j} - 1 ) j = i}$ |
| 7 | if ρₖ ≦ ρⱼ for all j then transfer \hat{x} to Dₖ |
| 8 | recalculate J, Jₑ, Jᵤ, mᵢ, mₖ |
| 9 | return m₁, . . . m_{c}}//over l |
| 10 | update π and μ}//over m |
| 11 | End |

Building Local Nets

The previous step, clustering, starts with normalizing the whole set of data assigned for learning. In building local nets, the data of each cluster is renormalized using local data minimal and maximal values of each one-dimensional input component. This locally normalized data is then utilized by the EA in building a set of local nets, one local net for each cluster. After training, the number of nodes for each of the trained local nets is optimized using the procedure optNumberNodes (testMSE) described hereinabove. Thus, in the following steps only these nets, uniquely selected by the criterion of test error from the sets of all trained local nets with the number of nodes N, 0≦N≦Nₘₐₓ, are utilized, in particular, as the elements of the global net.

Building Global Net and Predicting New Pattern

After the local nets have been defined, it is then necessary to generalize these to provide a general output over the entire input space, i.e., the global net must be defined.

Denote the set of trained local nets described in the previous subsection as:
Nⱼ(x),j=1, . . . C, (027)
where Nⱼ(x) is the trained local net for a cluster Dⱼ, C being the number of clusters. The default value of C is C=10 for a data set with the number of patterns P, 1000≦P≦5000, or C=5 for a data set with 300≦P≦500. For 500<P<1000 the default value of C can be calculated by linear interpolation C=5+(P−500)/100.

The global net N(x) is defined as:

$$N ( x ) = {c}_{0} + {\sum }_{j = 1}^{c} {c}_{j} {\tilde{N}}_{j} ( x ) , \qquad ( 028 )$$

where the parameters cⱼ, j=1, . . . C are adjustable on the total training set and comprise the global net weights. In order to train the network (the local nets already having been trained), the training data must be processed through the overall network in order to train the value of cⱼ. In order to train this net, data from the training set is utilized, it being noted that some of this data may be scattered. Therefore, it is necessary to determine to which of the local nets the data belongs such that a determination can be made as to which network has possession thereof.

For an arbitrary input pattern from the training set x=xₖ, the value of Ñⱼ(x) is defined as:

$${\tilde{N}}_{j} ( {x}_{k} ) = \{ \begin{matrix}{N}_{j} ( {x}_{k} ) , if {x}_{k} ∈ {D}_{j} \\ \begin{matrix}{N}_{j} ( {x}_{k} ) , elseif ‖ {x}_{k} - {m}_{j} ‖ \leq \\ 0.01 * {dLessIntra}_{ j} * {Intra}_{ j} ,\end{matrix} \\ {N}_{j} ( {x}_{k} ) exp [ - {( temp )}^{2} ] , else\end{matrix} \} \qquad ( 029 )$$

temp=∥xₖ−mⱼ∥/(0.01*dLessIntraⱼIntraⱼ), (030)
Intraⱼ and dLessIntraⱼ are the clustering parameters. The parameter Intraⱼ is defined as the shortest distance between the center mⱼ of the cluster Dⱼ and a pattern from the training set outside this cluster. The parameter dLessIntraⱼ is defined as the number of patterns from the cluster Dⱼ having distance less than Intraⱼ expressed in percents of the cluster size. Thus, the global net is defined for the elements of the training set. For any other input pattern first the cluster having minimum distance from its center to the pattern is determined. Then the input pattern is declared temporarily as the element of this cluster and equations (029) and (030) can be applied to this pattern as an element of the training set for calculation of the global net output. The target value of the plant output is assumed to become known by the moment of appearance of the next new pattern or a few seconds before that moment.
Retraining Local Nets

Referring now to FIG. 12, there is illustrated a diagrammatic view of the above description showing how a particular outlier data point is determined to be within a cluster. If, as set forth in equation (029), it is determined that the data point is within the cluster Dⱼ, it will be within a cluster 1302 that defines the data that was used to create the local network. This is the Dⱼ cluster data. However, the data that was used for the training set includes an outlier piece of data 1304 that is not disposed within the cluster 1302 and may not be within any other cluster. If a data point 1306 is considered, this is illustrated as being within the cluster 1302 and, therefore, it would be considered to be within a local net. The second condition of equation (029) is whether it is close enough to be considered within the cluster 1302, even though it resides outside. To define the loci of these points, the term Intraⱼ is the distance between the outlier data point 1304 in the pattern and the center of mass mⱼ. This provides a circle 1310 that, since the cluster 1302 was set forth as an ellipsoid, certain portions of the circle 1310 are within the cluster 1302 and certain portions are outside the cluster 1302. The data point 1304 is the point farthest from the center of mass outside of the cluster 1302. Hereafter, the term dLessIntraⱼ is defined as the percent of the data points in the pattern that are inside the circle that will be included at their full value within the cluster. Thus, the term dLessIntraⱼ is defined as the number of patterns in the cluster Dⱼ having a distance less than the distance to the data pattern 1304 as a percentage thereof. This will result in a dotted circle 1312. There will be a portion of this circle 1312 that is still outside the cluster 1302, but which will be considered to be part of the cluster. Anything outside of that will be reduced as set forth in the third portion of equation (029). This is illustrated in FIG. 13 where it can be seen that the data is contained within either a first cluster or a second cluster having respective centers mⱼ₁ and mⱼ₂, with all of the data in the clusters being defined by a range 1402 in the first cluster and a range 1404 in the second cluster. Once the boundaries of this range 1402 or the range 1404 are exceeded, even if the data point is contained within the cluster, it is weighted such that its contribution to the training is reduced. Therefore, it can be seen that when a new pattern is input during the training, it may only affect a single network. Since the data changes overtime, new patterns will arrive, which new patterns are required to be input to the training data set and the local nets retrained on that data. Since only a single local net needs to be retrained when new data is entered, it is fairly computationally efficient. Thus, if new patterns arrive every few minutes, it is only necessary that a local net is able to be trained before the arrival of the next pattern. With this computational efficiency, the training can occur in real time to provide a fully adaptable model of the system utilizing this clustering approach. In addition, whenever a new pattern is entered into the training set, one pattern is removed from the training set to maintain the size of the training set. This pattern is removed by randomly selecting the pattern. However, if there are time varying patterns, the oldest pattern could also be selected. Further, once a new pattern is entered into the data set for a cluster, the cluster is actually redefined in the portion of the input space it will occupy. Thus, the center of mass of the cluster can change and the boundaries of the cluster can change in an ongoing manner in real time.

Training/Retraining the Global Net

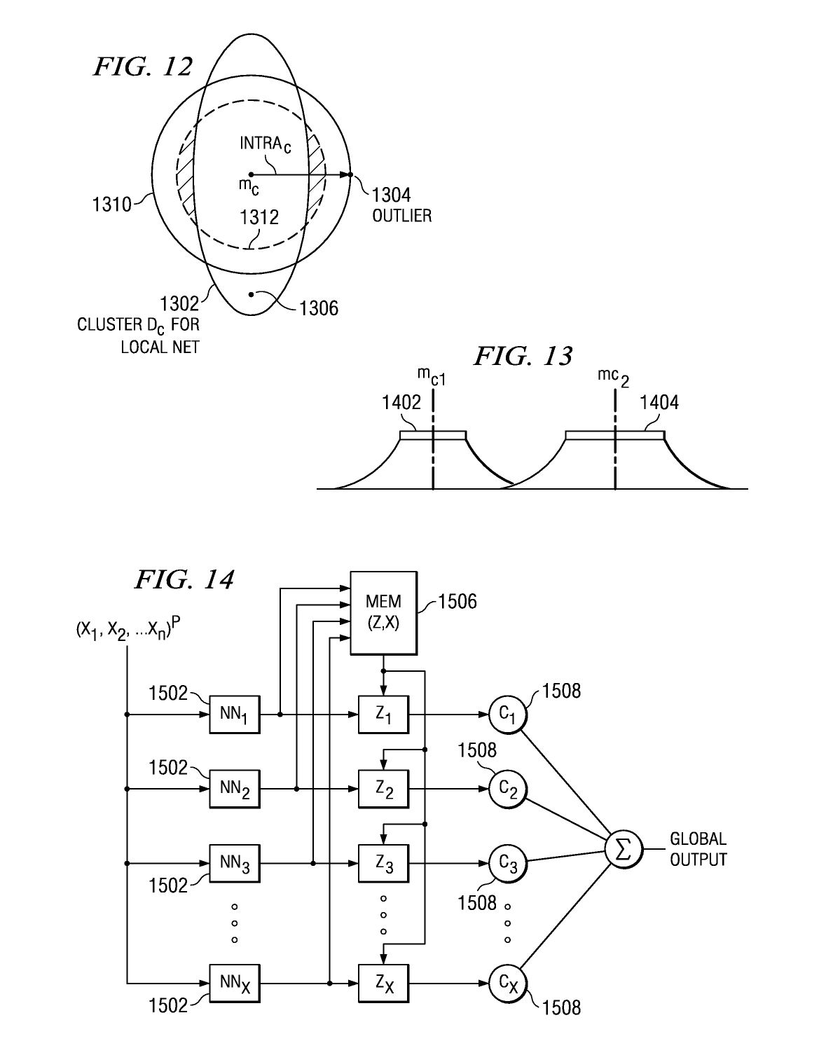

Referring now to FIG. 14, there is illustrated a diagrammatic view of the training operation for the global net. As noted hereinabove, there are provided a plurality of trained local nets 1502. The local nets 1502 are trained in accordance with the above noted operations. Once these local nets are trained, each of the local nets 1502 has the historical training patterns applied thereto such that one pattern can be input to the input of all of the nets 1502 which will result in an output being generated on the output of each of the local nets 1502, i.e., the predicted value. For example, if the local nets are operating in a power environment and are operable to predict the value of NOx, then they will provide an output a prediction of NOx. All of the inputs are applied to all of the networks 1502.

Each of the outputs from the local nets for each of the patterns constitutes a new predicted pattern which is referred to as a “Z-value” which is a predicted output value for a given pattern, defined as z=Ñⱼ(x). Therefore, for each pattern, there will be an historical input value and a predicted output value for each net. If there are 100 networks, then there will be 100 Z-values for each pattern and these are stored in a memory 1506 during the training operation of the global net. These will be used for the later retraining operation. During training of the global net, all that is necessary is to output the stored z values for the input training data and then input to the output layer of the global net the associated (y^{t}) value for the purpose of training the global weights, represented by weights 1508. As noted hereinabove, this is trained utilizing the RLR algorithm. During this training, the input values of each pattern are input and compared to the target output (y^{t}) associated with that particular pattern, an error generated and then the training operation continued. It is noted that, since the local nets 1502 are already trained, this then becomes a linear network.

For a retraining operation wherein a new pattern is received, it is only necessary for one local net 1502 to be trained, since the input pattern will only reside in a single one of the clusters associated with only a single one of the local networks 1502. To maintain computational efficiency, it is only necessary to retrain that network and, therefore, it is only necessary to generate a new output from that retrained local net 1502 for generation of output values, since the output values for all of the training patterns for the unmodified local nets 1502 are already stored in the memory 1506. Therefore, for each input pattern, only one local network, the modified one, is required to calculate a new Z-value, and the other Z-values for the other local nets are just fetched from the memory 1506 and then the weights 1508 are trained.

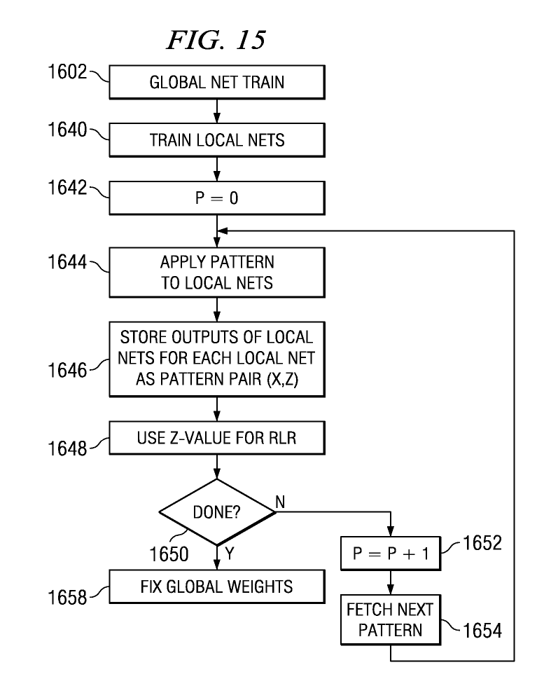

Referring now to FIG. 15, there is illustrated a flow chart depicting the original training operation, which is initiated at a block 1602 and then proceeds to a block 1604 to train the local nets. Once trained, they are fixed and then the program proceeds to a function block 1642 in order to set the pattern value equal to zero for the training operation to select the first pattern. The program then flows to a function block 1644 to apply the pattern to the local nets and generate the output value and then to a function block 1646 where the outputs of the local nets are stored in the memory as a pattern pair (x,z). This provides a Z-value for each local net for each pattern. The program then proceeds to a function block 1648 to utilize this Z-value in the RLR algorithm and then proceeds to a decision block 1650 to determine if all the patterns have been processed through the RLR. If not, the program flows along a “N” path to a function block 1652 in order to increment the pattern value to fetch the next pattern, as indicated by a function block 1654 and then back to function block 1644 to complete the RLR pattern. Once done, the program will then flow from the decision block 1650 to a function block 1658.

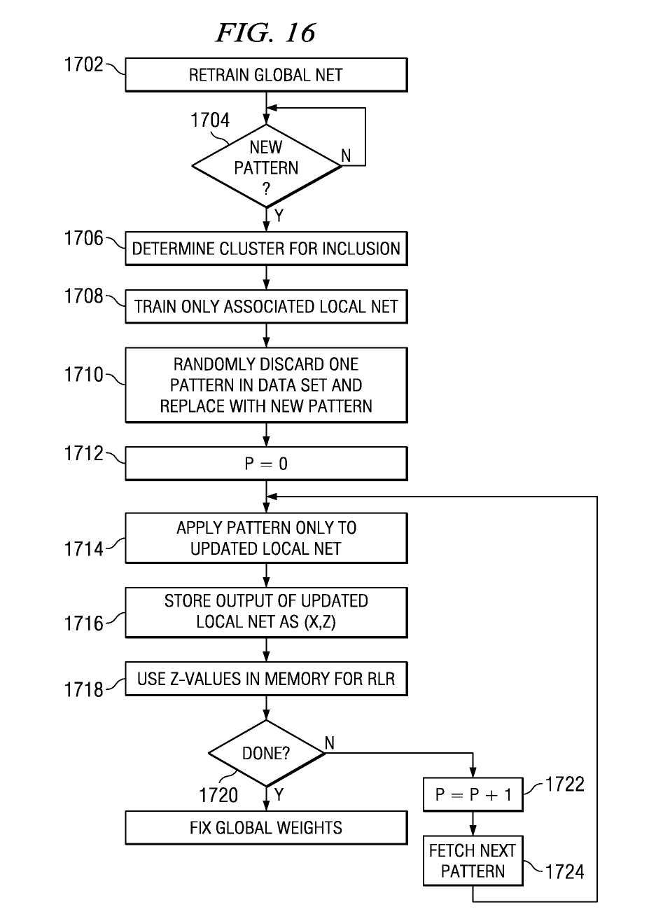

Referring now to FIG. 16, there is illustrated a flow chart depicting the operation of retraining the global net. This is initiated at a block 1702 and then proceeds to decision block 1704 to determine if a new pattern has been received. When received, the program will flow to a function block 1706 to determine the cluster for inclusion and then to a function block 1708 to train only that local net. The program then flows to function block 1710 to randomly discard one pattern in the data set and replace it with the new pattern. The program then flows to a function block 1712 to initiate a training operation of the global weights by selecting the first pattern and then to a function block 1714 to apply the selected pattern only to the updated local net. The program then flows to a function block 1716 to store the output of the updated local net as the new Z-value in association with the input value for that pattern such that there is a new Z-value for the local net associated with the pattern input. The program then flows to a function block 1718 to utilize the Z-values in memory for the RLR algorithm. The program then flows to a decision block 1720 to determine if the RLR algorithm has processed all of the patterns and, if not, the program flows to function block 1722 in order to increment the pattern value and then to a function block 1724 to fetch the next pattern and then to the input of function block 1714 to continue the operation.

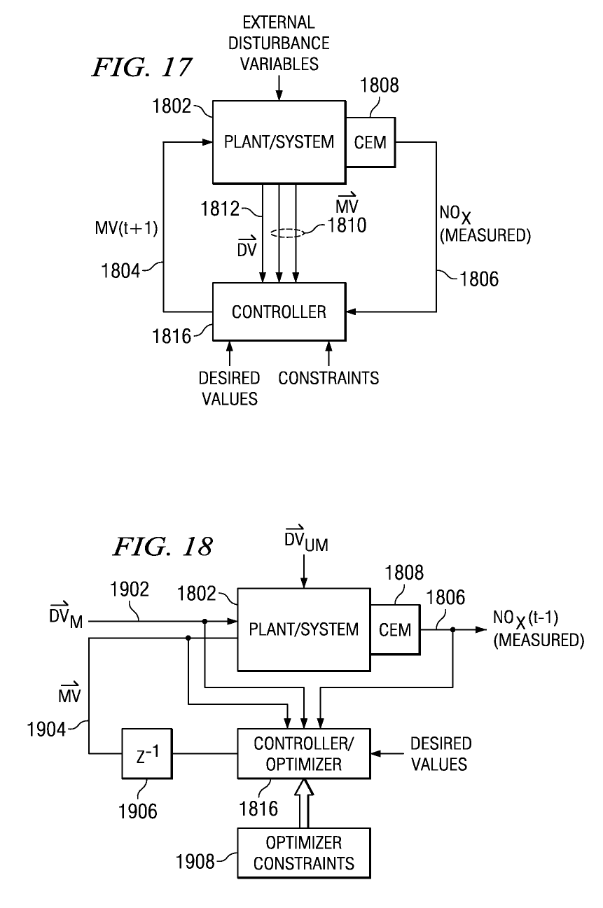

Referring now to FIG. 17, there is illustrated a diagrammatic view of a plant/system 1802 which is an example of one application of the model that is created with the above described model. The plant/system is operable to receive a plurality of control inputs on a line 1804, this constituting a vector of inputs referred to as the vector MV(t+1), which is the input vector “x,” which constitutes a plurality of manipulatable variables (MV) that can be controlled by the user. In a coal-fired plant, for example, the burner tilt can be adjusted, the amount of fuel supplied can be adjusted and oxygen content can be controlled. There, of course, are many other inputs that can be manipulated. The plant/system 1802 is also affected by various external disturbances that can vary as a function of time and these affect the operation of the plant/system 1802, but these external disturbances can not be manipulated by the operator. In addition, the plant/system 1802 will have a plurality of outputs (the controlled variables), of which only one output is illustrated, that being a measured NOx value on a line 1806. (Since NOx is a product of the plant/system 1802, it constitutes an output controlled variable; however, other such measured outputs that can be modeled are such things as CO, mercury or CO₂. All that is required is a measurement of the parameter as part of the training data set). This NOx value is measured through the use of a Continuous Emission Monitor (CEM) 1808. This is a conventional device and it is typically mounted on the top of an exit flue. The control inputs on lines 1804 will control the manipulatable variables, but these manipulatable variables can have the settings thereof measured and output on lines 1810. A plurality of measured disturbance variables (DVs), are provided on line 1812 (it is noted that there are unmeasurable disturbance variables, such as the fuel composition, and measurable disturbance variables such as ambient temperature. The measurable disturbance variables are what make up the DV vector on line 1812). Variations in both the measurable and unmeasurable disturbance variables associated with the operation of the plant cause slow variations in the amount of NOx emissions and constitute disturbances to the trained model, i.e., the model may not account for them during the training, although measured DVs maybe used as input to the model, but these disturbances do exist within the training data set that is utilized to train in a neural network model.

The measured NOx output and the MVs and DVs are input to a controller 1816 which also provides an optimizer operation. This is utilized in a feedback mode, in one embodiment, to receive various desired values and then to optimize the operation of the plant by predicting a future control input value MV(t+1) that will change the values of the manipulatable variables. This optimization is performed in view of various constraints such that the desired value can be achieved through the use of the neural network model. The measured NOx is utilized typically as a bias adjust such that the prediction provided by the neural network can be compared to the actual measured value to determine if there is any error between the prediction provided by the neural network. The neural network utilizes the globally generalized ensemble model which is comprised of a plurality of locally trained local nets with a generalized global network for combining the outputs thereof to provide a single global output (noting that more than one output can be provided by the overall neural network).

Referring now to FIG. 18, there is illustrated a more detailed diagram of the system of FIG. 17. The plant/system 1802 is operable to receive the DVs and MVs on the lines 1902 and 1904, respectively. Note that the DVs can, in some cases, be measured (DV_{M}), such that they can be provided as inputs, such as is the case with temperature, and in some cases, they are unmeasurable variables (DV_{UM}), such as the composition of the fuel. Therefore, there will be a number of DVs that affect the plant/system during operation which cannot be input to the controller/optimizer 1816 during the optimization operation. The controller/optimizer 1816 is configured in a feedback operation wherein it will receive the various inputs at time “t−1” and it will predict the values for the MVs at a future time “t” which is represented by the delay box 1906. When a desired value is input to the controller/optimizer, the controller/optimizer will utilize the various inputs at time “t−1” in order to determine a current setting or current predicted value for NOx at time “t” and will compare that predicted value to the actual measured value to determine a bias adjust. The controller/optimizer 1816 will then iteratively vary the values of the MVs, predict the change in NOx, which is bias adjusted by the measured value and compared to the predicted value in light of the adjusted MVs to a desired value and then optimize the operation such that the new predicted value for the change in NOx compared to the desired change in NOx will be minimized. For example, suppose that the value of NOx was desired to be lowered by 2%. The controller/optimizer 1816 would iteratively optimize the MVs until the predicted change is substantially equal to the desired change and then these predicted MVs would be applied to the input of the plant/system 1802.

When the plant consists of a power generation unit, there are a number of parameters that are controllable. The controllable parameters can be NOx output, CO output, steam reheat temperature, boiler efficiency, opacity an/or heat rate.

It will be appreciated by those skilled in the art having the benefit of this disclosure that this invention provides a non linear network representation of a system utilizing a plurality of local nets trained on select portions of an input space and then generalized over all of the local nets to provide a generalized output. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A predictive global model for modeling a system, comprising:
a plurality of local models, each having:
an input layer for mapping into an input space,
a hidden layer for storing a representation of the system that is trained on a set of historical data, wherein each of said local models is trained on only a select and different portion of the historical data, and
an output layer for mapping to an associated at least one local output,
wherein said hidden layer is operable to map said input layer through said stored representation to said at least one local output; and
a global output layer for mapping the at least one outputs of all of said local models to at least one global output, said global output layer generalizing said at least one outputs of said local models across the stored representations therein.

2. The system of claim 1, wherein said data in said historical data set is arranged in clusters, each with a center in the input data space with the remaining data in the cluster being in close association therewith and each of said local models associated with one of said clusters.

3. The system of claim 2, wherein each of said local models comprises a non-linear model.

4. The system of claim 2, wherein said global output layer comprises a plurality of global weights and said at least one output of said local models are mapped to said at least one global output through an associated one of said global weights by the following relationship:
$$N ( x ) = {c}_{0} + {\sum }_{j = 1}^{c} {c}_{j} {\tilde{N}}_{j} ( x ) ,$$
where the set of global weights is (c₀, c₁, . . . , c_{c}) and Nⱼ comprises the at least one output of said associated local model.

5. The system of claim 4, wherein said global weights are trained on the data set comprised of the input data in said historical data set and associated outputs of said local models, such that said global output layer comprises a linear model.

6. The system of claim 5, wherein said output layer is trained with a recursive linear regression (RLR) algorithm.

7. The system of claim 5, and further comprising a storage device for storing the output values from said local models during training in conjunction with said historical data set for each of said local models.

8. The system of claim 5, and further comprising an adaptive system for retraining the global model when new data is present.

9. The system of claim 8, wherein said adaptive system comprises:
a data set modifier for including the new data in said historical data set;
a cluster detector to determine the closest one of said clusters to the new data and modifying said determined one of said closest one of said clusters to include the new data;
a local model retraining system for retraining only the one of said local models associated with said modified cluster; and
a global output layer retraining system for retraining said global output layer.

10. The system of claim 9, and further comprising a storage device for storing the output values from said local models during training in conjunction with said historical data set for each of said local models.

11. The system of claim 10, wherein said local model retraining system is operable to update the contents of said storage device after retaining of said local model and said global output layer retraining system utilizes only the contents of said storage system during retraining, such that reprocessing of training data through said local models is not required.

12. A predictive system for modeling the operation of at least one output of a process that operates in defined operating regions of an input space; comprising:
a set of training data of input values and corresponding measured output values for the at least one output of the process taken during the operation of the process within the defined operating regions;
a plurality of local models of the process, each associated with one of the defined operating regions and each trained on the portion of said training data for the defined operating region associated therewith;
a generalization model for combining the outputs of all of said plurality of local models to provide a global output corresponding to the at least one output of the process, wherein said global model is trained on substantially all of said training data, with said local models remaining fixed during the training of said generalization model.

13. The system of claim 12, wherein each of said local models comprises:
an input layer for mapping into an input space of inputs associated with the inputs to the process,
a hidden layer for storing a representation of the process that is trained on the portion of said training data for the defined operating region associated therewith, and
an output layer for mapping to an associated at least one output,
wherein said hidden layer is operable to map said input layer through said stored representation to the at least one output.

14. The system of claim 13, wherein said data in said training data set is arranged in clusters, each with a center of mass in the input space with the remaining of the portion of said training data in the cluster being in close association therewith and each of said local models associated with one of said clusters.

15. The system of claim 14, wherein each of said local models comprises a non-linear model.

16. The system of claim 14, wherein said generalization model comprises a plurality of global weights and the at least one output of each of said local models are mapped to said at least one global output through an associated one of said global weights by the following relationship:
$$N ( x ) = {c}_{0} + {\sum }_{j = 1}^{c} {c}_{c} j {N}_{j} ( x ) ,$$
where the set of global weights is (c₀, c₁, . . . , c_{c}) and Nⱼ comprises the at least one output of said associated local model.

17. The system of claim 16, wherein said global weights are trained on substantially all of the training data with the representation stored in each of said local models remaining fixed.

18. The system of claim 17, wherein said output layer of each of said local models is trained with a recursive linear regression (RLR) algorithm.

19. The system of claim 17, and further comprising a storage device for storing the output values from said local models during training thereof in conjunction with said historical data set for each of said local models.

20. The system of claim 17, and further comprising an adaptive system for retraining the global model when new measured data is present.

21. The system of claim 20, wherein said adaptive system comprises:
a data set modifier for including the new data in said training data;
a cluster detector to determine the closest one of said clusters to the new data and modifying said determined one of said closest one of said clusters to include the new data;
a local model retraining system for retraining only the one of said local models associated with said modified cluster; and
a global output layer retraining system for retraining said global output layer.

22. The system of claim 21, and further comprising a storage device for storing the output values from said local models during training in conjunction with said training data for each of said local models.

23. The system of claim 22, wherein said local model retraining system is operable to update the contents of said storage device after retraining of said local model and said global output layer retraining system utilizes only the contents of said storage system during retraining, such that reprocessing of training data through said local models is not required.

24. A controller for controlling a process, comprising:
a control input to the process and measurable outputs from the process; and
a control system operable to receive the measurable outputs from the process and generate control inputs thereto, said control system including a predictive model having:
a plurality of local models of the process, each associated with one of a plurality of defined operating regions of the process and each trained on training data associated with the associated defined operating region, and
a generalization model for combining the outputs of all of said plurality of local models to provide a global output corresponding to at least one output of the process, wherein said global model is trained on substantially all of said training data on which each of said local models was trained, with said local models remaining fixed during the training of said generalization model, and
said predictive model utilized in generating the control inputs to the process.

25. The controller of claim 24, wherein said control system is operable to control air emissions from the process from the group consisting of NOx, CO, mercury and CO₂.

26. The controller of claim 24, wherein the process is a power generation plant and said control system is operable to control operating parameters of the plant consisting of the one or more elements of the group consisting of NOx, CO, steam reheat, temperature, boiler efficiency opacity and heat rate.

26. The controller of claim 24, wherein the process is a power generation plant and each of said local nets and its associated defined region comprises a load range of the power generation plant.

27. The controller of claim 26, wherein said load range is comprised of the group consisting of a low load range, a mid load range and a high load range.

28. The system of claim 24, wherein each of said local models comprises:
an input layer for mapping into an input space of inputs associated with the inputs to the process,
a hidden layer for storing a representation of the process that is trained on said training data associated with the defined operating region; and
an output layer for mapping to an associated at least one output,
wherein said hidden layer is operable to map said input layer through said stored representation to the at least one output.

29. The system of claim 28, wherein said data in each said training data associated with each of said defined regions is arranged in clusters, each with a center of mass in the input space with the remaining of the portion of said training data in the cluster being in close association therewith and each of said local models associated with one of said clusters.

30. The system of claim 29, wherein each of said local models comprises a non-linear model.

31. The system of claim 29, wherein said generalization model comprises a plurality of global weights and the at least one output of each of said local models are mapped to said at least one global output through an associated one of said global weights by the following relationship:
$$N ( x ) = {c}_{0} + {\sum }_{j = 1}^{c} {c}_{j} {\tilde{N}}_{j} ( x ) ,$$
where the set of global weights is (c₀, c₁, . . . , c_{c}) and Nⱼ comprises the at least one output of said associated local model.

32. The system of claim 24, wherein said global weights are trained on substantially all of the training data associated with all of said defined regions with the representation stored in each of said local models remaining fixed.

33. The system of claim 32, wherein said output layer of each of said local models is trained with a recursive linear regression (RLR) algorithm.

34. The system of claim 32, and further comprising a storage device for storing the output values from said local models during training thereof in conjunction with said historical data set for each of said local models.

35. The system of claim 32, and further comprising an adaptive system for retaining the global model when new measured data is present.

36. The system of claim 35, wherein said adaptive system comprises:
a data set modifier for including the new data in said training data for select ones of said defined regions;
a cluster detector to determine the closest one of said clusters to the new data and modifying said determined one of said closest one of said clusters to include the new data;
a local model retraining system for retraining only the one of said local models associated with said modified cluster; and
a global output layer retraining system for retraining said global output layer.

37. The system of claim 36, and further comprising a storage device for storing the output values from said local models during training in conjunction with said training data for each of said local models.

38. The system of claim 37, wherein said local model retraining system is operable to update the contents of said storage device after retraining of said local model and said global output layer retraining system utilizes only the contents of said storage system during retraining, such that reprocessing of training data through said local models is not required.

39. The system of claim 24, wherein control system utilizes an optimizer in conjunction with the model to determine manipulated variables that comprise inputs to the process.
